(19) United States
(12) Patent Application Publication
(10) Pub. No.: US 2021/0095157 A1
(43) Pub. Date: Apr. 1, 2021

(54) COLOR-STABLE CURING COMPOSITIONS COMPRISING POLYISOCYANATES OF (CYCLO)ALIPHATIC DIISOCYANATES

(71) Applicant: BASF SE, Ludwigshafen am Rhein (DE)

(72) Inventor: Harald SCHAEFER, Ludwigshafen (DE)

(73) Assignee: BASF SE, Ludwigshafen am Rhein (DE)

(21) Appl. No.: 16/621,879

(22) PCT Filed: Jul. 13, 2018
(86) PCT No.: PCT/EP2018/069124

§ 371 Date: Dec. 12, 2019

(30) Foreign Application Priority Data
Jul. 20, 2017 (EP) 17182436.0

(51) Int. Cl. C09D 175/04; C08G 18/79; C08G 18/24

(52) U.S. Cl. CPC C09D 175/04; C08G 18/246; C08G 18/791

(57) ABSTRACT

The present invention relates to a novel process for preparing polyisocyanates of (cyclo)aliphatic diisocyanates that are stable to color drift in solvents and in the presence of Lewis acids.

The present invention relates to novel color drift-stable compositions comprising polyisocyanates of (cyclo)aliphatic diisocyanates, Lewis-acidic organic metal compounds capable of accelerating the reaction of isocyanate groups with isocyanate-reactive groups, solvents and specific phenolic antioxidants of relatively high molecular weight.

U.S. Pat. No. 6,376,584 B1 describes various stabilizers for use in polyurethane compositions, in which polyisocyanates are reacted with polyols in the presence of dibutyltin dilaurate. It especially describes sterically hindered amines.

There is no disclosure of the stability problems that arise when polyisocyanate compositions are stored, especially not mixed with a catalyst. The text describes only the phenolic antioxidants of relatively low molecular weight that are customary on the market, and not the problems of their volatility.

U.S. Pat. No. 7,122,588 B2 describes coatings, including polyurethane coatings, stabilized with esters of hypophosphorous acid to improve lifetime and to counter discoloration.

In particular, there is no disclosure of the stability problems that arise when polyisocyanate compositions are mixed with a catalyst and stored. Moreover, the stabilization described therein is still inadequate, and so there continues to be a need for improved stabilization. There is no description of the specific problems of the volatility of additives.

DE 19630903 describes the stabilization of isocyanates with the aid of various phosphorus compounds and ionol (BHT).

There is no description in each case of the presence of catalysts for the reaction between isocyanate groups and groups reactive toward them. Owing to its very small molar mass, problems with BHT include migration, emission and fogging problems.

WO 2005/089085 describes polyisocyanate compositions as curing agents for two component (2K) polyurethane coatings which, as well as a catalyst for the reaction between isocyanate groups and groups reactive toward them, comprises a stabilizer mixture selected from sterically hindered phenols and secondary arylamines, and also trialkyl and triaryl phosphites, especially trialkyl phosphites. The examples explicitly disclose polyisocyanate compositions consisting of Tolonate HDT isocyanurate, dibutyltin dilaurate as catalyst, butyl acetate/methyl amyl ketone/xylene=1:1:0.5 as solvent and additives.

Sterically hindered phenols mentioned are 2,4-dimethyl-6-butylphenol, 4,4′-methylenebis(2,6-di-tert-butylphenol), 2,6-di-tert-butyl-N,N′-dimethylamino-p-cresol, butylated hydroxyanisole, 2,6-di-tert-butylphenol, 2,4,6-tri-tert-butylphenol, 2-tert-butylphenol, 2,6-diisopropylphenol, 2-methyl-6-tert-butylphenol, 2,4-dimethyl-6-tert-butylphenol, 4-(N,N-dimethylaminomethyl)-2,6-di-tert-butylphenol, 4-ethyl-2,6-di-tert-butylphenol.

All the examples specify BHT (3,5-bis-tert-butyl-4-hydroxytoluene) in combination with the aliphatic phosphites tributyl phosphite and tri(isooctyl) phosphite.

A disadvantage of the sterically hindered phenols mentioned is that they have low molar masses that can lead to problems in the coating. The bicyclic sterically hindered phenol 4,4′-methylenebis(2,6-di-tert-butylphenol) has a molar mass of 424 g/mol, the largest monocyclic phenol 2,4,6-tri-tert-butylphenol a molar mass of 262 g/mol, and BHT a molar mass of 220 g/mol. Too small a molar mass, especially that of BHT, leads to migration, and possibly to exudation, to emissions as a result of higher volatility, and fogging. Fogging is undesirable especially in interior applications, for example in automobiles.

BHT in combination with NOX (gas ovens, forklift truck exhaust gas) leads to yellow or pink coloring. BHT, being hazardous to water (N; R51-53), is toxicologically not preferred. BHT is considered to be the main cause of fogging in automobile interior applications.

The product mixtures described in patent specifications WO 2008/116893, WO 2008/116894, WO 2008/116895 comprise polyisocyanate, Lewis acid, secondary antioxidant such as thioether (WO 2008/116893), phosphonite (WO 2008/116895) or phosphonate (WO 2008/116894), and optionally sterically hindered phenol, acidic stabilizers and coatings additives. The phenol is described as a compound having exactly one phenolic hydroxyl group per aromatic ring and in which at least one ortho position, preferably both ortho positions, relative to the functional group bear(s) a tert-butyl group. Such sterically hindered phenols may also be constituents of a polyphenolic system with multiple phenol groups, such as pentaerythritol tetrakis[(3-(3,5-di-tert-butyl-4-hydroxyphenyl)propionate] (e.g. Irganox® 1010), 3,3′,3″,5,5′,5″-hexa-tert-butyl-α,α′,α″-(mesitylene-2,4,6-triyl)tri-p-cresol (e.g. Irganox® 1330), 1,3,5-tris(3,5-di-tert-butyl-4-hydroxybenzyl)-1,3,5-triazine-2,4,6(1H,3H,5H)-trione (e.g. Irganox® 3114), each products from BASF SE.

The examples explicitly cite benzenepropionic acid 3,5-bis(1,1-dimethylethyl)-4-hydroxy-C7-C9-branched alkyl ester (Irganox® 1135 from BASF SE). This has the advantage over BHT of being liquid and hence better incorporable into polyisocyanates, and has a higher molar mass of 399 g/mol. But this means that the molar mass is not always sufficient in relation to possible fogging.

WO 2013/060614 gives an analogous description of polyisocyanate compositions comprising polyisocyanate, Lewis-acidic organic metal compound capable of accelerating the reaction of isocyanate groups with isocyanate-reactive groups, a Brønsted acid having a pKa less than 4, sterically hindered phenol, solvent, optionally coatings additives.

The same restrictions are applicable here as in the predecessor documents.

EP 1558675 B1 describes the preparation and use of sterically hindered phenols having color numbers below 100 Hz. These have the following structures:

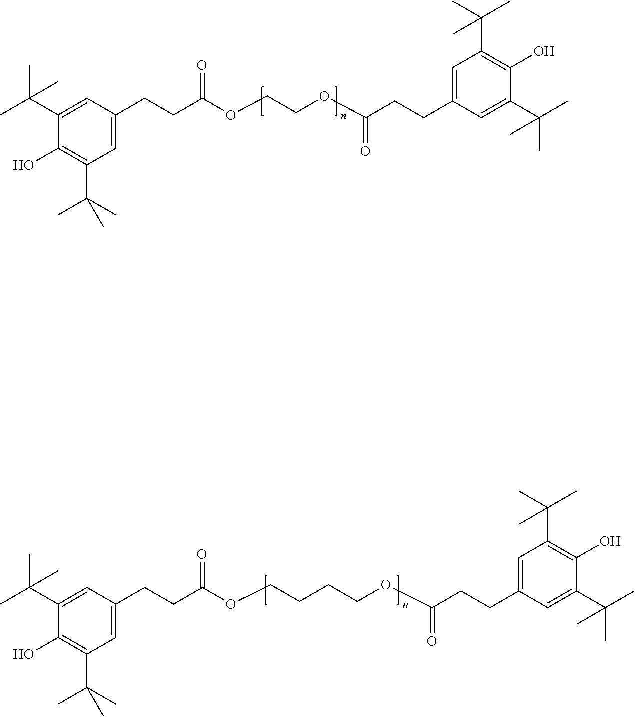

According to claim 8 of EP 1558675 B1, the polyether may have a molar mass of 120-3000 g/mol, i.e. the two compound types mentioned have a molar mass of 640-3520 g/mol. There is no mention of addition of these stabilizers to a (cyclo)aliphatic polyisocyanate. Accordingly, there is no mention either of storage of isocyanates with stabilizer or of storage of isocyanate with stabilizer in the presence of Lewis acids.

US 20060167207 describes mixtures of monomeric isocyanates and stabilizers having a molar mass of 600-10 000 g/mol, preferably 700-900 g/mol, with at least two phenolic groups. Isocyanates mentioned include monomeric tolylene diisocyanate TDI and methylene diphenyl diisocyanate MDI.

The patent does not contain any pointer to stabilization of aliphatic polyisocyanates, especially not in the presence of Lewis acids.

It was an object of the present invention to provide storage-stable aliphatic polyisocyanate compositions that are color-stable, the stabilizers of which have good incorporability into polyisocyanates and permit unproblematic occupational and health hygiene in processing and during and after application in terms of odor, their toxicology, migration and/or fogging, and the stabilizing effect of which is improved over the prior art.

The object was achieved by polyisocyanate compositions comprising
(A) at least one (cyclo)aliphatic polyisocyanate obtainable by reacting at least one monomeric isocyanate,
(B) at least one sterically hindered phenol having a melting point of below 40° C. and a number-average molecular weight Mₙ between 650 and 2550 g/mol, comprising at least two phenolic groups,
(C) at least one Lewis-acidic organic metal compound capable of accelerating the reaction of isocyanate groups with isocyanate-reactive groups,
(D) at least one solvent,
(E) optionally at least one further antioxidant,
(F) optionally at least one Brønsted acid having a pKa less than 4,
(G) optionally other coatings additives.

Polyisocyanate compositions of this kind have good color stability over time in the course of storage (“color drift”) and can be reacted with components comprising isocyanate-reactive groups in polyurethane coatings.

The monomeric isocyanates used may be aliphatic or cycloaliphatic, which is referred to as (cyclo)aliphatic for short in this document. Particular preference is given to aliphatic isocyanates.

Cycloaliphatic isocyanates are those which comprise at least one cycloaliphatic ring system.

Aliphatic isocyanates are those which comprise exclusively linear or branched chains, in other words acyclic compounds.

The monomeric isocyanates are preferably diisocyanates bearing exactly two isocyanate groups.

In principle, monomeric higher isocyanates having an average of more than two isocyanate groups are also an option. Suitable examples for this purpose are triisocyanates such as triisocyanatononane and 2′-isocyanatoethyl 2,6-di isocyanatohexanoate.

These monomeric isocyanates do not contain any substantial products of reaction of the isocyanate groups with themselves.

The monomeric isocyanates are preferably isocyanates having 4 to 20 carbon atoms. Examples of typical diisocyanates are aliphatic diisocyanates such as tetramethylene diisocyanate, pentamethylene 1,5-diisocyanate, hexamethylene diisocyanate (1,6-diisocyanatohexane), octamethylene diisocyanate, decamethylene diisocyanate, dodecamethylene diisocyanate, tetradecamethylene diisocyanate, derivatives of lysine diisocyanate (e.g. methyl or ethyl 2,6-diisocyanatohexanoate), trimethylhexane diisocyanate or tetramethylhexane diisocyanate, cycloaliphatic diisocyanates such as 1,4-, 1,3- or 1,2-diisocyanatocyclohexane, 4,4′- or 2,4′-di(isocyanatocyclohexyl)methane, 1-isocyanato-3,3,5-trimethyl-5-(isocyanatomethyl)cyclohexane (isophorone diisocyanate), 1,3- or 1,4-bis(isocyanatomethyl)cyclohexane or 2,4- or 2,6-diisocyanato-1-methylcyclohexane, and also 3(or 4),8 (or 9)-bis(isocyanatomethyl)tricyclo[5.2.1.0^{2,6}]decane isomer mixtures.

Particular preference is given to hexamethylene 1,6-diisocyanate, pentamethylene 1,5-diisocyanate, 1,3-bis(isocyanatomethyl)cyclohexane, isophorone diisocyanate and 4,4′- or 2,4′-di(isocyanatocyclohexyl)methane, very particular preference to isophorone diisocyanate and hexamethylene 1,6-diisocyanate, especial preference to hexamethylene 1,6-diisocyanate.

It is also possible for mixtures of the isocyanates mentioned to be present.

Isophorone diisocyanate is usually in the form of a mixture, specifically a mixture of the cis and trans isomers, generally in a proportion of about 60:40 to 90:10 (w/w), preferably of 70:30-90:10.

Dicyclohexylmethane 4,4′-diisocyanate may likewise be in the form of a mixture of the different cis and trans isomers.

For the present invention it is possible to use not only those diisocyanates which are obtained by phosgenating the corresponding amines but also those which are prepared without the use of phosgene, i.e. by phosgene-free processes. According to EP-A-0 126 299 (U.S. Pat. No. 4,596,678), EP-A-126 300 (U.S. Pat. No. 4,596,679), and EP-A-355 443 (U.S. Pat. No. 5,087,739), for example, (cyclo)aliphatic diisocyanates, such as hexamethylene 1,6-diisocyanate (HDI), isomeric aliphatic diisocyanates having 6 carbon atoms in the alkylene radical, 4,4′- or 2,4′-di(isocyanatocyclohexyl)methane, and 1-isocyanato-3 isocyanatomethyl-3,5,5-trimethylcyclohexane (isophorone diisocyanate or IPDI), can be prepared by reacting the (cyclo)aliphatic diamines with, for example, urea and alcohols to give (cyclo)aliphatic biscarbamic esters and subjecting said esters to thermal cleavage into the corresponding diisocyanates and alcohols. The synthesis is usually effected continuously in a circulation process and optionally in the presence of N-unsubstituted carbamic esters, dialkyl carbonates, and other by-products recycled from the reaction process. Diisocyanates obtained in this way generally contain a very low or even unmeasurable fraction of chlorinated compounds, which is advantageous, for example, in applications in the electronics industry.

In one embodiment of the present invention, the isocyanates used contain less than 100 ppm of hydrolyzable chlorine, preferably less than 50 ppm, particularly less than 30 ppm and especially less than 20 ppm. This can be measured, for example, by ASTM method D4663-98. The contents of total chlorine are, for example, below 1000 ppm, preferably below 800 ppm and more preferably below 500 ppm (determined by argentometric titration after hydrolysis).

It is of course also possible to use mixtures of those monomeric isocyanates which have been obtained by reaction of the (cyclo)aliphatic diamines with, for example, urea and alcohols and cleavage of the (cyclo)aliphatic biscarbamic esters obtained with those diisocyanates which have been obtained by phosgenation of the corresponding amines.

The polyisocyanates (A), which can be formed by oligomerizing the monomeric isocyanates, are generally characterized as follows:

The mean NCO functionality of such compounds is generally at least 1.8 and may be up to 8, preferably 2 to 5, and more preferably 2.4 to 4.

The content of isocyanate groups after oligomerization, calculated as NCO=42 g/mol, is generally 5% to 25% by weight, preferably 15% to 24% by weight, unless indicated otherwise.

Preferably, the polyisocyanates (A) are the following compounds:
1) Polyisocyanates having isocyanurate groups and derived from aliphatic and/or cycloaliphatic diisocyanates. Particular preference is given here to diisocyanates based on hexamethylene diisocyanate and isophorone diisocyanate. The isocyanurates present are, in particular, tris(isocyanatoalkyl) and/or tris(isocyanatocycloalkyl) isocyanurates, which constitute cyclic trimers of the diisocyanates, or are mixtures with their higher homologs having more than one isocyanurate ring. The isocyanatoisocyanurates generally have an NCO content of 10 to 30% by weight, in particular 15 to 25% by weight, and an average NCO functionality of 2.6 to 8.
   The polyisocyanates having isocyanurate groups may, to a smaller degree, also comprise allophanate and/or urethane groups, preferably with a content of bound alcohol of less than 2%, based on the polyisocyanate.
2) Polyisocyanates having uretdione groups, with aliphatically and/or cycloaliphatically bonded isocyanate groups, especially those derived from hexamethylene diisocyanate or isophorone diisocyanate. Uretdione diisocyanates are cyclic dimerization products of diisocyanates.
   The polyisocyanates having uretdione groups are frequently obtained in a mixture with other polyisocyanates, especially those mentioned under 1). Polyisocyanates having uretdione groups typically have functionalities of 2 to 3.
   This also includes uretdione/isocyanurate mixtures of any composition, especially with a content of monomeric uretdione (dimer) of 1-40%, especially 3-15%, especially 5-10%.
   To this end, the diisocyanates are converted under reaction conditions under which both uretdione groups and the other polyisocyanates are formed, or the uretdione groups are formed first and these are subsequently converted to the other polyisocyanates, or the diisocyanates are first converted to the other polyisocyanates and these are then converted to products containing uretdione groups.
3) Polyisocyanates having biuret groups and having cycloaliphatically or aliphatically attached isocyanate groups, especially tris(6-isocyanatohexyl)biuret or mixtures thereof with higher homologs thereof. These polyisocyanates having biuret groups generally have an NCO content of 18% to 24% by weight and an average NCO functionality of 2.8 to 6.
4) Allophanate and/or urethane group-containing polyisocyanates having aliphatically or cycloaliphatically bonded isocyanate groups, as formed, for example, by reaction of excess amounts of diisocyanate, for example hexamethylene diisocyanate or isophorone diisocyanate, with mono- or polyhydric alcohols. These polyisocyanates having allophanate and/or urethane groups generally have an NCO content of 12% to 24% by weight and an average NCO functionality of 2.0 to 4.5. Such allophanate and/or urethane group-containing polyisocyanates may be prepared without catalysis or preferably in the presence of catalysts, for example ammonium carboxylates or hydroxides, or allophanatization catalysts, for example bismuth, cobalt, cesium, Zn(II) or Zr(IV) compounds, in each case in the presence of monohydric, dihydric or polyhydric, preferably monohydric, alcohols.
   These allophanate and/or urethane group-containing polyisocyanates frequently occur in mixed forms with the polyisocyanates mentioned under 1).
5) Polyisocyanates comprising iminooxadiazinedione groups, preferably derived from hexamethylene diisocyanate or isophorone diisocyanate. Such polyisocyanates comprising iminooxadiazinedione groups are preparable from diisocyanates by means of specific catalysts, for example phosphonium hydrogen difluoride.
6) Carbodiimide-modified polyisocyanates.
7) Hyperbranched polyisocyanates, of the kind known for example from DE-A1 10013186 or DE-A1 10013187.
8) Polyurethane-polyisocyanate prepolymers, from di- and/or polyisocyanates with alcohols.
9) Polyurea-polyisocyanate prepolymers.
10) The polyisocyanates 1)-9), preferably 1), 3), 4) and 5), after preparation thereof, can be converted to biuret or allophanate/urethane group-containing polyisocyanates having cycloaliphatically or aliphatically bonded isocyanate groups. Biuret groups are formed, for example, by addition of water or reaction with amines. Allophanate/urethane groups are formed by reaction with monohydric, dihydric or polyhydric, preferably monohydric, alcohols, optionally in the presence of suitable catalysts. These biuret or allophanate/urethane group-containing polyisocyanates generally have an NCO content of 10% to 25% by weight and an average NCO functionality of 3 to 8.
11) Hydrophilically modified polyisocyanates, i.e. polyisocyanates which, as well as the groups described under 1)-10), comprise those which arise in a formal sense through addition of molecules having NCO-reactive groups and hydrophilizing groups onto the isocyanate groups of the above molecules. The latter are nonionic groups such as alkyl polyethylene oxide and/or ionic groups derived from phosphoric acid, phosphonic acid, sulfuric acid or sulfonic acid, or salts thereof.
12) Modified polyisocyanates for dual-cure applications, i.e. polyisocyanates which, as well as the groups described under 1)-9), comprise those which arise in a formal sense through addition of molecules having NCO-reactive groups and groups crosslinkable by UV or actinic radiation onto the isocyanate groups of the above molecules. These molecules are, for example, hydroxyalkyl (meth)acrylates and other hydroxyl-vinyl compounds.

The diisocyanates or polyisocyanates listed above may also be at least partly in blocked form.

Classes of compound used for blocking are described in D. A. Wicks, Z. W. Wicks, Progress in Organic Coatings, 36, 148-172 (1999), 41, 1-83 (2001) and 43, 131-140 (2001).

Examples of classes of compound used for blocking are phenols, imidazoles, triazoles, pyrazoles, oximes, N-hydroxyimides, hydroxybenzoic esters, secondary amines, lactams, CH-acidic cyclic ketones, malonic esters or alkyl acetoacetates.

In a preferred embodiment of the present invention, the polyisocyanate is selected from the group consisting of isocyanurates, biurets, allophanate/(urethane)/isocyanurate mixtures, asymmetric isocyanurates, preferably from the group consisting of isocyanurates, allophanate/(urethane)/isocyanurate mixtures, and it is more preferably a polyisocyanate containing isocyanurate groups.

In a particularly preferred embodiment, the polyisocyanate comprises polyisocyanates which comprise isocyanurate groups and derive from hexamethylene 1,6-diisocyanate.

In a further preferred embodiment, the polyisocyanate is a mixture of polyisocyanates comprising isocyanurate groups, most preferably of hexamethylene 1,6-diisocyanate and isophorone diisocyanate.

In a particularly preferred embodiment, the polyisocyanate is a mixture comprising low-viscosity polyisocyanates, preferably polyisocyanates comprising isocyanurate groups as described under 1), having a viscosity of 600-1500 mPa*s, especially below 1200 mPa*s, low-viscosity allophanates (allophanate/urethane/isocyanurate mixtures) as described under 4) having a viscosity of 200-1600 mPa*s, especially 600-1500 mPa*s, and/or polyisocyanates comprising iminooxadiazinedione groups as described under 5).

In this specification, unless noted otherwise, the viscosity is reported at 23° C. in accordance with DIN EN ISO 3219/A.3 in a cone/plate system with a shear rate of 1000 s⁻¹.

The process for preparing the polyisocyanates may take place as described in WO 2008/68198, especially from page 20 line 21 to page 27 line 15 therein, which is hereby incorporated into the present application by reference.

The reaction can be discontinued, for example, as described therein from page 31 line 19 to page 31 line 31, and working up may take place as described therein from page 31 line 33 to page 32 line 40, which in each case is hereby part of the present application by reference.

The reaction can alternatively and preferably be effected as described in WO 2005/087828 for ammonium alpha-hydroxycarboxylate catalysts. The reaction can be stopped, for example, as described in WO 2005/087828 from page 11 line 12 to page 12 line 5, which is hereby incorporated into the present application by reference.

The reaction can alternatively be effected as described in CN 10178994 Å or CN 101805304.

In the case of thermally labile catalysts, it is additionally also possible to stop the reaction by heating the reaction mixture to a temperature above at least 80° C., preferably at least 100° C., more preferably at least 120° C. The heating of the reaction mixture is generally already sufficient for this purpose, as required for removal of the unconverted isocyanate by distillation in the workup.

In the case both of thermally non-labile catalysts and of thermally labile catalysts, it is possible to stop the reaction at relatively low temperatures by addition of deactivators.

Examples of suitable deactivators are hydrogen chloride, phosphoric acid, organic phosphates, such as dibutyl phosphate or diethylhexyl phosphate, and carbamates such as hydroxyalkyl carbamate.

These compounds are added neat or diluted in a suitable concentration as necessary to stop the reaction.

Sterically hindered phenols (B) in the context of the invention have the function of a primary antioxidant. This is typically understood by the person skilled in the art to mean compounds that scavenge free radicals.

The phenols (B) have a melting point of below 40° C., have a number-average molecular weight Mₙ between 650 and 2550, preferably 650 to 2000, more preferably 700 to 1500 and most preferably 700 to 1000 g/mol (number-average molecular weight Mₙ, measured via GPC against polystyrene standards in THF at (23±1°) C.), and comprise at least two phenolic groups.

Here and hereinafter, molecular weight figures are determined by gel permeation chromatography (GPC) against polystyrene standard in tetrahydrofuran at (23±1°) C.

More preferably, the phenols (B) have a narrow molecular weight distribution, i.e. a polydispersity (PD=Mw/Mn) of 1.0 to 1.5, more preferably of 1.0 to 1.2.

The melting point is preferably below 30° C., more preferably below 23° C., especially below 5° C.

The phenols (B) preferably have exactly one phenolic hydroxyl group per aromatic ring, wherein both ortho positions relative to the phenolic hydroxyl group are substituted by alkyl radicals, preferably by C₁-C₁₀ alkyl, more preferably by C₄-C₆ alkyl, even more preferably by sec-butyl, tert-butyl or tert-amyl, and especially by tert-butyl in both ortho positions.

The phenols (B) preferably have the following structure of a polyalkylene oxide bis-, tris- or tetra[3-(3,5-dialkyl-4-hydroxyphenyl)propionate]:

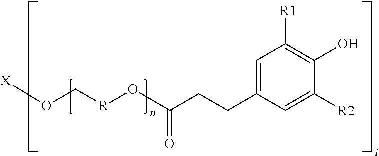

where

R is an optionally substituted C₁-C₅-alkyl radical which is linear or branched and may be different from repeat unit [—CH₂—R—O-] to repeat unit [—CH₂—R—O—], preferably selected from R═—CH₂—, —(CH₂)₂, —CH(CH₃)— and —(CH₂)₃—, more preferably with R the same in each repeat unit, especially preferably with R═—CH₂—, or selected from —(CH₂)₂— and —CH(CH₃)— or selected from —CH₂—, —(CH₂)₂— and —CH(CH₃)—;

i is an integer from 2 to 4;

n is a natural number (including 0), where the 2, 3 or 4 n per compound (B) may be the same or different, and where the sum total of the 2, 3 or 4 n in the compound (B) on average over all molecules (B) is greater than 2 and not more than 45;

R1, R2 are identical or different alkyl groups, preferably C₁-C₁₀ alkyl groups, more preferably C₄-C₆ alkyl groups, most preferably sec-butyl groups, tert-butyl groups or tert-amyl groups, and especially tert-butyl groups, where the 2, 3 or 4 R1 and R2 per compound (B) may be the same or different

and

X is an aliphatic di-, tri- or tetrafunctional aliphatic linear or branched radical.

The difunctional X radical is preferably a C₁-C₆, more preferably ethylene —(CH₂)₂—, propylene —(CH₂—)₃— and/or —(CH₂—CH(CH₃))—, most preferably ethylene —(CH₂)₂—. The trifunctional radical is preferably derived from trimethylolpropane or glycerol (i.e. the aliphatic radical without the OH groups). The tetrafunctional radical is preferably derived from pentaerythritol.

The phenols (B) may be converted on the basis of an optionally polyalkoxylated di-, tri- or tetraalcohol with subsequent esterification/transesterification with 3-(3,5-dialkyl-4-hydroxyphenyl)propionic acids or derivatives thereof, for example with methyl 3-(3,5-di-tert-butyl-4-hydroxyphenyl)propionate with removal of methanol.

More preferably, the phenols (B) have the following structure of a polyalkylene oxide bis[3 -(3,5-alkyl-4-hydroxyphenyl)propionate]:

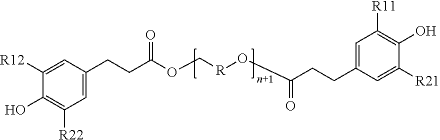

where

R is an optionally substituted C₁-C₅-alkyl radical which is linear or branched and may be different from repeat unit [—CH₂—R—O-] to repeat unit [—CH₂—R—O—], preferably selected from R═—CH₂—, —(CH₂)₂, —CH(CH₃)— and —(CH₂)₃— (the latter derived from poly-THF, especially of molar mass about 250, 650, 1000, 1800 or 2000 g/mol), more preferably with R the same in each repeat unit, especially preferably with R═—CH₂—, or selected from —(CH₂)₂— and —CH(CH₃)— or selected from —CH₂—, —(CH₂)₂— or —CH(CH₃)—;

n is a natural number, where (n+1) in the compound (B) on average over all molecules (B) is greater than 3 and not more than 46;

and

R11, R21, R12 and R22 are identical or different alkyl groups, preferably C₁-C₁₀ alkyl groups, more preferably C₄-C₆ alkyl groups, most preferably sec-butyl groups, tert-butyl groups or tert-amyl groups, and especially tert-butyl groups.

In a preferred embodiment, the compound (B) is a polymer by the OECD definition.

Melting point in the case of crystalline compounds (B) is understood to mean the melting point determined with the aid of a DSC measurement to DIN EN ISO 11357/3 at a heating rate of 2 K/min. Melting point in the case of amorphous or semicrystalline compounds (B) is understood to mean a glass transition temperature determined with the aid of a DSC measurement to DIN EN ISO 11357/2 at a heating rate of 20 K/min. In the context of this document, this glass transition temperature is referred to as melting point.

The preparation of corresponding compounds is described, for example, in EP 1303565 B1, example 3, (based on polyethylene oxide with low color number), EP 1558675 B1, EP 1529814, US 20060167207, which is hereby incorporated into the present disclosure by reference.

The sterically hindered phenols (B) preferably have a color number below 100 Hz, more preferably below 50 Hz, most preferably below 20 Hz.

The sterically hindered phenols (B) are typically added in amounts, based on the polyisocyanate (A), of 100 to 10 000 ppm by weight, preferably 200 to 5000 and more preferably 250 to 3000 ppm by weight, even more preferably 300 to 1500 ppm by weight.

Examples of useful Lewis-acidic organic metal compounds (C) include tin compounds, such as tin(II) salts of organic carboxylic acids, e.g. tin(II) diacetate, tin(II) dioctoate, tin(II) bis(ethylhexanoate) and tin(II) dilaurate, and the dialkyltin(IV) salts of organic carboxylic acids, e.g. dimethyltin diacetate, dibutyltin diacetate, dibutyltin dibutyrate, dibutyltin bis(2-ethylhexanoate), dibutyltin dilaurate, dibutyltin maleate, dioctyltin dilaurate and dioctyltin diacetate.

Further preferred Lewis-acidic organic metal compounds are zinc salts, for example zinc(II) diacetate and zinc(II) dioctoate.

Tin- and zinc-free alternatives used include organic metal salts of bismuth, zirconium, titanium, aluminum, iron, manganese, nickel and cobalt.

These are, for example, zirconium tetraacetylacetonate (e.g. K-KAT® 4205 from King Industries); zirconium dionates (e.g. K-KAT® XC-9213; XC-A 209 and XC-6212 from King Industries); bismuth compounds, more particularly tricarboxylates (e.g. K-KAT® 348, XC-B221; XC-C227, XC 8203 from King Industries); aluminum dionate (e.g. K-KAT® 5218 from King Industries). Tin-free and zinc-free catalysts are otherwise also offered, for example, under the trade name Borchi® Kat from Borchers, Tego® from Evonik, TIB Kat® from TIB Chemicals or BICAT® from Shepherd, Lausanne.

Bismuth and cobalt catalysts, cerium salts such as cerium octoates, and cesium salts may also be used as catalysts.

Bismuth catalysts are especially bismuth carboxylates, especially bismuth octoates, ethylhexanoates, neodecanoates or pivalates; for example K-KAT® 348 and XK-601 from King Industries, TIB KAT® 716, 716LA, 716XLA, 718, 720, 789 from TIB Chemicals and those from Shepherd Lausanne, and catalyst mixtures of, for example, bismuth and zinc organyls.

Further metal catalysts are described by Blank et al. in Progress in Organic Coatings, 1999, vol. 35, pages 19-29.

These catalysts are suitable for solvent-based, water-based and/or blocked systems.

Molybdenum catalysts, tungsten catalysts and vanadium catalysts are described especially for the conversion of blocked polyisocyanates in WO 2004/076519 and WO 2004/076520.

Cesium salts as well can be used as catalysts. Useful cesium salts include those compounds in which the following anions are used: F—, Cl—, ClO—, ClO₃—, ClO₄—, Br—, I—, IO₃—, CN—, OCN—, NO₂—, NO—, HCO₃—, CO₃²—, S²—, SH—, HSO—, SO₃²—, HSO₄—, S₄²—, S₂O₂²—, S₂O₄²—, S₂O₅²—, S₂O₆²—, S₂O₇²—, S₂O₈²—, H₂PO₂—, H₂PO₄—, HPO₄²—, PO₄³—, P₂O₇⁴—, (OCₙH₂ₙ₊₁)—, (CₙH₂ₙ₋₁O₂)—, (CₙH₂ₙ₋₃O₂)— and (Cₙ₊₁H₂ₙ₋₂O₄)²—, where n represents the numbers 1 to 20. Preference is given to cesium carboxylates in which the anion obeys the formulae (CₙH₂ₙ₋₁O₂)— and (Cₙ₊₁H₂ₙ₋₂O₄)²— where n is 1 to 20. Particularly preferred cesium salts have, as anions, monocarboxylates of the general formula (CₙH₂ₙ₋₁O₂)— where n represents the numbers 1 to 20. In this connection, particular mention should be made of formate, acetate, propionate, hexanoate and 2-ethylhexanoate.

Preferred Lewis-acidic organic metal compounds are dimethyltin diacetate, dibutyltin dibutyrate, dibutyltin bis(2-ethylhexanoate), dibutyltin dilaurate, dioctyltin dilaurate, zinc(II) diacetate, zinc(II) dioctoate, zirconium acetylacetonate and zirconium 2,2,6,6-tetramethyl-3,5-heptanedionate, and bismuth compounds.

Particular preference is given to dibutyltin dilaurate.

In addition, a solvent or solvent mixture (D) is also present.

Solvents usable for the polyisocyanate component, and also the binder components and any other components, are those that do not have any groups reactive toward isocyanate groups or capped isocyanate groups and in which the polyisocyanates are soluble to an extent of at least 10% by weight, preferably to an extent of at least 25%, more preferably to an extent of at least 50%, even more preferably to an extent of at least 75%, particularly to an extent of at least 90% and especially to an extent of at least 95% by weight.

Examples of such solvents are aromatic (including alkylated benzenes and naphthalenes) and/or (cyclo)aliphatic hydrocarbons and mixtures thereof, ketones, esters, alkoxylated alkyl alkanoates, ethers, ether esters, or mixtures of the solvents.

Preferred aromatic hydrocarbon mixtures are those that comprise predominantly aromatic C₇ to C₁₄ hydrocarbons and may encompass a boiling range from 110° C. to 300° C., particular preference being given to toluene, o-, m- or p-xylene, trimethylbenzene isomers, tetramethylbenzene isomers, ethylbenzene, cumene, tetrahydronaphthalene and mixtures comprising these compounds.

Examples include the Solvesso® range from ExxonMobil Chemical, particularly Solvesso® 100 (CAS No. 64742-95-6, predominantly C₉ and C₁₀-aromatics, boiling range about 154° C.-178° C.), 150 (boiling range about 182° C.-207° C.) and 200 (CAS No. 64742-94-5), and also the Shellsol® range from Shell, Caromax® (e.g. Caromax®18) from Petrochem Carless and Hydrosol® from DHC (e.g. Hydrosol® A 170). Hydrocarbon mixtures composed of paraffins, cycloparaffins and aromatics are also commercially available under the Kristalloel (for example Kristalloel 30, boiling range about 158-198° C. or Kristalloel 60: CAS No. 64742-82-1), white spirit (for example likewise CAS No. 64742-82-1) or Solvent naphtha (light: boiling range about 155-180° C., heavy: boiling range about 225-300° C.) trade names. The aromatics content of such hydrocarbon mixtures is generally more than 90% by weight, preferably more than 95% by weight, more preferably more than 98% by weight and most preferably more than 99% by weight. It may be advantageous to use hydrocarbon mixtures having a particularly reduced content of naphthalene.

(Cyclo)aliphatic hydrocarbons include for example decalin, alkylated decalin and isomer mixtures of linear or branched alkanes and/or cycloalkanes.

The content of aliphatic hydrocarbons is generally less than 5%, preferably less than 2.5% and more preferably less than 1% by weight.

Esters are, for example, n-butyl acetate, isobutyl acetate, ethyl acetate, 1-methoxy-2-propyl acetate and 2-methoxyethyl acetate.

Ethers are, for example, dioxane and the dimethyl, -ethyl or -n-butyl ethers of ethylene glycol, diethylene glycol, triethylene glycol, propylene glycol, dipropylene glycol or tripropylene glycol.

Ketones are, for example, acetone, diethyl ketone, ethyl methyl ketone, isobutyl methyl ketone, methyl amyl ketone, cyclohexanone and tert-butyl methyl ketone.

Ether esters are, for example, ethyl ethoxypropionate EEP, methoxymethyl acetate, butoxyethyl acetate BGA, ethoxy-1-methylethyl acetate, methoxy-1-methylacetate.

Preferred solvents are n-butyl acetate, ethyl acetate, 1-methoxy-2-propyl acetate, 2-methoxyethyl acetate, methyl amyl ketone, and mixtures thereof, especially with the above-detailed aromatic hydrocarbon mixtures, especially xylene and Solvesso® 100.

Mixtures of this kind may be created in a volume ratio of 5:1 to 1:5, preferably in a volume ratio of 4:1 to 1:4, more preferably in a volume ratio of 3:1 to 1:3 and most preferably in a volume ratio of 2:1 to 1:2.

Preferred examples are butyl acetate/xylene, methoxypropyl acetate/xylene 1:1, butyl acetate/Solvent naphtha 100 1:1, butyl acetate/Solvesso® 100 1:2 and Kristalloel 30/Shellsol® A 3:1.

It has been found that the solvents are problematic to different degrees in relation to the objective. Polyisocyanate compositions comprising ketones or aromatic mixtures (for example Solvent Naphtha mixtures) are particularly critical in relation to color number development in the course of storage. By contrast, esters, ethers, comparatively narrow aromatic cuts such as xylene and isomer mixtures thereof are less problematic. This is surprising in that xylenes, analogously to the aromatic mixtures, likewise bear benzylic hydrogen atoms that could be involved in color development. An additional factor is that Solvent Naphtha mixtures, depending on the source and storage times, can have distinctly different effects on color number drift when used in the polyisocyanate compositions.

In addition, further antioxidants (E) may be present.

Further primary antioxidants are, for example, secondary arylamines.

The secondary antioxidants are preferably selected from the group consisting of phosphites, phosphonites, phosphonates and thioethers.

Phosphites are compounds of the P(OR^{a})(OR^{b}) (OR^{c}) type with R^{a}, R^{b}, R^{c} as identical or different aliphatic or aromatic radicals (which may also form cyclic or spiro structures).

Preferred phosphonites are described in WO 2008/116894, particularly from page 11 line 8 to page 14 line 8 therein, which is hereby incorporated into the present disclosure by reference.

Preferred phosphonates are described in WO 2008/116895, particularly from page 10 line 38 to page 12 line 41, which is hereby incorporated into the present disclosure by reference.

These are especially dialkyl phosphonates and dialkyl diphosphonates.

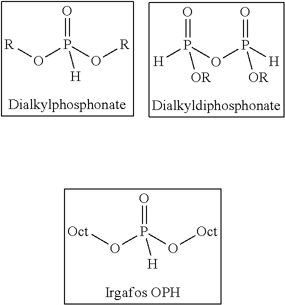

Examples of these are mono- and di-C₁- to C₁₂-alkyl phosphonates and mixtures thereof, preferably the dialkyl phosphonates, more preferably those with C₁- to C₈-alkyl groups, most preferably with C₁- to C₈-alkyl groups and especially those with C₁—, C₂—, C₄- or C₈-alkyl groups.

The alkyl groups in dialkyl phosphonates may be the same or different; they are preferably the same.

Examples of C₁- to C₁₂-alkyl groups are methyl, ethyl, isopropyl, n-propyl, n-butyl, isobutyl, sec-butyl, tert-butyl, n-hexyl, n-heptyl, n-octyl, n-decyl, n-dodecyl, 2-ethylhexyl and 2-propylheptyl, preferably Irgafos® OPH di-n-octyl phosphonate (see image above), di-n-butyl phosphonate and di-(2-ethylhexyl) phosphonate, especially di-n-octyl phosphonate.

Phosphonic acids are generally used in amounts based on the polyisocyanate of 10 to 1000, preferably 20 to 600 and more preferably 50 to 300 ppm by weight.

Preferred thioethers are described in WO 2008/116893, particularly from page 11 line 1 to page 15 line 37 therein, which is hereby incorporated into the present disclosure by reference.

Brønsted acids (F) are H-acidic compounds. They are preferably F1) mono- and/or dialkyl phosphates, F2) arylsulfonic acids and/or F3) phosphonates.

Mono- and/or dialkyl phosphates F1 are, for example, mono- and di-C₁- to C₁₂-alkyl phosphates and mixtures thereof, preferably those with C₁- to C₈-alkyl groups, most preferably with C₂- to C₈-alkyl groups and especially those with C₄- to C₈-alkyl groups.

The alkyl groups in dialkyl phosphates may be the same or different; they are preferably the same.

Examples of C₁- to C₁₂-alkyl groups are methyl, ethyl, isopropyl, n-propyl, n-butyl, isobutyl, sec-butyl, tert-butyl, n-hexyl, n-heptyl, n-octyl, n-decyl, n-dodecyl, 2-ethylhexyl and 2-propylheptyl.

These are especially mono- and dialkyl phosphates and mixtures thereof, such as
mono-/di(ethylhexyl) phosphate
mono-/dibutyl phosphate
mono-/diethyl phosphate

In addition, these may be:
Nacure® 4000 (formerly Nacure® C 207), a nonspecific alkyl phosphate, from King Industries
Nacure® 4054, a nonspecific alkyl phosphate, from King Industries
Cycat® 296-9, a nonspecific alkyl phosphate, from Cytec

For use in polyisocyanates, preference is given to use in the form of a 100% product or in a solvent that does not react with isocyanate groups.

Compounds F1 are generally added in amounts based on the polyisocyanate of 5 to 1000, preferably 10 to 600, more preferably 20 to 200 and most preferably 20 to 80 ppm by weight.

Arylsulfonic acids F2 are, for example, benzene or naphthalene derivatives, especially alkylated benzene or naphthalene derivatives.

Examples of preferred sulfonic acids include 4-alkylbenzenesulfonic acids with alkyl radicals of 6 to 12 carbon atoms, for example 4-hexylbenzenesulfonic acid, 4-octylbenzenesulfonic acid, 4-decylbenzenesulfonic acid or 4-dodecylbenzenesulfonic acid. The products here may, in a manner known in principle, also be industrial products having a distribution of various alkyl radicals of different length.

Particularly preferred acids include:
benzenesulfonic acid
para-toluenesulfonic acid
para-ethylbenzenesulfonic acid
para-dodecylbenzenesulfonic acid
bisnonylnaphthalenesulfonic acid
bisnonylnaphthalenebissulfonic acid
bisdodecylnaphthalenesulfonic acid
Nacure® XC-C210 (hydrophobic acid catalyst of unspecified structure from King Industries)

Compounds F2 are generally added in amounts based on the polyisocyanate of 1 to 600, preferably 2 to 100 and more preferably 5 to 50 ppm by weight.

Phosphonates F3 already been described under the antioxidants (E). The same applies here.

Further, typical coatings additives (G) used may be the following, for example: UV stabilizers such as UV absorbers and suitable free-radical scavengers (especially HALS compounds, hindered amine light stabilizers), activators (accelerators), drying agents, fillers, pigments, dyes, antistatic agents, flame retardants, thickeners, thixotropic agents, surface-active agents, viscosity modifiers, plasticizers or chelating agents. Preference is given to UV stabilizers.

Suitable UV absorbers include oxanilides, triazines and benzotriazoles (the latter available, for example, as Tinuvin® grades from BASF SE) and benzophenones (e.g. Chimassorb® 81 from BASF SE). Preference is given, for example, to 95% benzenepropanoic acid, 3-(2H-benzotriazol-2-yl)-5-(1,1-dimethylethyl)-4-hydroxy-, C7-9-branched and linear alkyl esters; 5% 1-methoxy-2-propyl acetate (e.g. Tinuvin® 384) and α-[3-[3-(2H-benzotriazol-2-yl)-5-(1,1-dimethylethyl)-4-hydroxyphenyl]-1-oxopropyl]-ω-hydroxypoly(oxo-1,2-ethanediyl) (e.g. Tinuvin® 1130), in each case products, for example, of BASF SE. DL-alpha-Tocopherol, tocopherol, cinnamic acid derivatives and cyanoacrylates can likewise be used for this purpose.

These may be used alone or together with suitable free-radical scavengers, examples being sterically hindered amines (often also referred to as HALS or HAS compounds; hindered amine (light) stabilizers) such as 2,2,6,6-tetramethylpiperidine, 2,6-di-tert-butylpiperidine or derivatives thereof, for example bis(2,2,6,6-tetramethyl-4-piperidyl) sebacate. These are obtainable, for example, as Tinuvin® products and Chimassorb® brands from BASF SE. Preference in joint use with Lewis acids, however, is given to those hindered amines that are N-alkylated, examples being bis(1,2,2,6,6-pentamethyl-4-piperidinyl) [[3,5-bis(1,1-dimethylethyl)-4-hydroxyphenyl]methyl]butylmalonate (e.g. Tinuvin® 144 from BASF SE); a mixture of bis(1,2,2,6,6-pentamethyl-4-piperidinyl)sebacate and methyl(1,2,2,6,6-pentamethyl-4-piperidinyl) sebacate (e.g. Tinuvin® 292 from BASF SE); or which are N—(O-alkylated), such as, for example, decanedioic acid bis(2,2,6,6-tetramethyl-1-(octyloxy)-4-piperidinyl) ester, reaction products with 1,1-dimethylethyl hydroperoxide and octane (e.g., Tinuvin®123 from BASF SE), and especially the HALS triazine “2-aminoethanol, reaction products with cyclohexane and peroxidized N-butyl-2,2,6,6-tetramethyl-4-piperidinamine-2,4,6-trichloro-1,3,5-triazine reaction product” (e.g. Tinuvin® 152 from BASF SE).

UV stabilizers are typically used in amounts of 0.1% to 5.0% by weight, based on the solid components present in the preparation.

Suitable thickeners include not only free-radically (co)polymerized (co)polymers but also customary organic and inorganic thickeners such as hydroxymethylcellulose or bentonite.

Chelating agents which can be used include, for example, ethylenediamineacetic acid and salts thereof and also β-diketones.

As component (H) in addition it is possible for fillers, dyes and/or pigments to be present.

Pigments in the true sense are, according to CD Römpp Chemie Lexikon—Version 1.0, Stuttgart/New York: Georg Thieme Verlag 1995, with reference to DIN 55943, particulate “colorants that are organic or inorganic, chromatic or achromatic and are virtually insoluble in the application medium”.

Virtually insoluble here means a solubility at 25° C. below 1 g/1000 g application medium, preferably below 0.5, more preferably below 0.25, very particularly preferably below 0.1, and in particular below 0.05 g/1000 g application medium.

Examples of pigments in the true sense comprise any desired systems of absorption pigments and/or effect pigments, preferably absorption pigments. There are no restrictions whatsoever on the number and selection of the pigment components. They may be adapted as desired to the particular requirements, such as the desired perceived color, for example, as described in step a), for example. It is possible for example for the basis to be all the pigment components of a standardized mixed coat system.

Effect pigments are all pigments which exhibit a platelet-shaped construction and give a surface coating specific decorative color effects. The effect pigments are, for example, all of the pigments which impart effect and can be used typically in vehicle finishing and industrial coatings. Examples of such effect pigments are pure metallic pigments, such as aluminum, iron or copper pigments; interference pigments, such as titanium dioxide-coated mica, iron oxide-coated mica, mixed oxide-coated mica (e.g., with titanium dioxide and Fe₂O₃ or titanium dioxide and Cr₂O₃), metal oxide-coated aluminum; or liquid-crystal pigments, for example.

The coloring absorption pigments are, for example, typical organic or inorganic absorption pigments that can be used in the coatings industry. Examples of organic absorption pigments are azo pigments, phthalocyanine pigments, quinacridone pigments, and pyrrolopyrrole pigments. Examples of inorganic absorption pigments are iron oxide pigments, titanium dioxide and carbon black.

Dyes are likewise colorants, and differ from the pigments in their solubility in the application medium; i.e., they have a solubility at 25° C. of more than 1 g/1000 g in the application medium.

Examples of dyes are azo, azine, anthraquinone, acridine, cyanine, oxazine, polymethine, thiazine and triarylmethane dyes. These dyes may find application as basic or cationic dyes, mordant dyes, direct dyes, disperse dyes, development dyes, vat dyes, metal complex dyes, reactive dyes, acid dyes, sulfur dyes, coupling dyes or substantive dyes.

Coloristically inert fillers are all substances/compounds which on the one hand are coloristically inactive, i.e., exhibit a low intrinsic absorption and have a refractive index similar to that of the coating medium, and which on the other hand are capable of influencing the orientation (parallel alignment) of the effect pigments in the surface coating, i.e., in the applied coating film, and also properties of the coating or of the coating compositions, such as hardness or rheology, for example. Inert substances/compounds which can be used are given by way of example below, but without restricting the concept of coloristically inert, topology-influencing fillers to these examples. Suitable inert fillers meeting the definition may be, for example, transparent or semitransparent fillers or pigments, such as silica gels, blancfixe, kieselguhr, talc, calcium carbonates, kaolin, barium sulfate, magnesium silicate, aluminum silicate, crystalline silicon dioxide, amorphous silica, aluminum oxide, microspheres or hollow microspheres made, for example, of glass, ceramic or polymers, with sizes of 0.1-50 μm, for example. Further inert fillers used may be any desired solid inert organic particles, such as urea-formaldehyde condensates, micronized polyolefin wax and micronized amide wax, for example. The inert fillers can in each case also be used in a mixture. It is preferred, however, to use only one filler in each case.

Preferred fillers include silicates, for example silicates obtainable by hydrolysis of silicon tetrachloride, such as Aerosil® from Degussa, siliceous earth, talc, aluminum silicates, magnesium silicates, and calcium carbonates, etc.

In a preferred embodiment, in a first step, polyisocyanates (A) are converted to a polyisocyanate composition with sterically hindered phenol (B), optionally with at least one further component selected from antioxidant (E), Brønsted acid (F), additive (G) and/or solvent (D). Especially preferred are blends of polyisocyanate (A) with sterically hindered phenol (B) with at least one solvent (D) or with at least one solvent (D) and at least one antioxidant (E). These mixtures are converted to polyisocyanate compositions of the invention in a second step by adding Lewis acid (C), optionally further components, especially solvent (D).

Preferred solvents for premixtures of such a polyisocyanate component in the first step are n-butyl acetate, ethyl acetate, 1-methoxy-2-propyl acetate, 2-methoxyethyl acetate, xylene, Solvesso® 100, and mixtures thereof.

The polyisocyanate compositions of the invention are, for example, of the following composition:

(A) 20% to 99%, preferably 20% to 95%, more preferably 30% to 90% by weight, most preferably 40% to 80% by weight,

(B) 100 to 10 000 ppm by weight of sterically hindered phenol, preferably 200 to 5000, more preferably 250 to 3000 and most preferably 300 to 1500 ppm by weight,

(C) 1 to 10 000 ppm by weight of Lewis acid, preferably 20 to 2000 and more preferably 50 to 500 ppm by weight,

(D) 1% to 80% by weight, preferably 5% to 80% by weight of solvent, more preferably 10-70% by weight, most preferably 20% to 60% by weight,

(E) 0 to 2000 ppm of further antioxidants, preferably 10-600 ppm, more preferably 50-300 ppm,

(F) 0 to 1000 ppm by weight of Brønsted acid, preferably 2 to 300 and more preferably 10 to 100 ppm by weight,

(G) 0% to 5% by weight of additives, with the proviso that the ppm by weight figures for components (B), (C), (E), (F) and (G) are based on polyisocyanate (A) and the sum total of components (A) and (D) is always 100% by weight,

(H) optionally, in addition to the above components (A) to (G), pigments.

If components (H) are present, these are not included in the composition of components (A) to (G).

The polyisocyanate compositions of the invention can advantageously be used in polyurethane coatings as curing components in addition to at least one binder.

The reaction with binders can optionally be effected after a long period of time as required by corresponding storage of the polyisocyanate composition. The polyisocyanate composition is preferably stored at room temperature, but can also be stored at higher temperatures. In practice, heating of such a polyisocyanate composition in storage to 30° C., 40° C., even up to 60° C., is possible.

The binders may, for example, be polyacrylate polyols, polyester polyols, polyether polyols, polyurethane polyols; polyurea polyols; polyester polyacrylate polyols; polyester polyurethane polyols; polyurethane polyacrylate polyols, polyurethane-modified alkyd resins; fatty acid-modified polyester polyurethane polyols, copolymers with allyl ethers, graft polymers of the substance groups mentioned with, for example, different glass transition temperatures, and mixtures of the binders mentioned. Preference is given to polyacrylate polyols, polyester polyols and polyurethane polyols, particular preference to polyacrylate polyols and polyester polyols.

Preferred OH numbers, measured to DIN 53240-2 (potentiometric), are 40-350 mg KOH/g of solid resin for polyesters, preferably 80-180 mg KOH/g of solid resin, and 15-250 mg KOH/g of solid resin for polyacrylate polyols, preferably 80-160 mg KOH/g.

In addition, the binders may have an acid number to DIN EN ISO 3682 (potentiometric) up to 200 mg KOH/g, preferably up to 150 and more preferably up to 100 mg KOH/g.

Polyacrylate polyols preferably have a molecular weight M of at least 500 and more preferably at least 1200 g/mol. The molecular weight M may in principle be unlimited at the upper end, preferably up to 50 000, more preferably up to 20 000 and even more preferably up to 10 000 g/mol, and especially up to 5000 g/mol.

The hydroxy-functional monomers (see below) are included in the copolymerization in such amounts as to result in the abovementioned hydroxyl numbers of the polymers.

These are hydroxyl-containing copolymers of at least one hydroxyl-containing (meth)acrylate with at least one further polymerizable comonomer selected from the group consisting of alkyl (meth)acrylates, vinylaromatics, α,β-unsaturated carboxylic acids and other monomers.

Examples of alkyl (meth)acrylates include C₁-C₂₀-alkyl (meth)acrylates, vinylaromatics are those having up to 20 carbon atoms, α,β-unsaturated carboxylic acids also include the anhydrides thereof, and other monomers are, for example, vinyl esters of carboxylic acids comprising up to 20 carbon atoms, ethylenically unsaturated nitriles, vinyl ethers of alcohols comprising 1 to 10 carbon atoms and, less preferably, aliphatic hydrocarbons having 2 to 8 carbon atoms and 1 or 2 double bonds.

Preferred alkyl (meth)acrylates are those having a C₁-C₁₀-alkyl radical, such as methyl methacrylate, methyl acrylate, n-butyl acrylate, ethyl acrylate, and 2-ethylhexyl acrylate.

In particular, mixtures of the alkyl (meth)acrylates are also suitable.

Vinyl esters of carboxylic acids having 1 to 20 carbon atoms are, for example, vinyl laurate, vinyl stearate, vinyl propionate, and vinyl acetate.

α,β-Unsaturated carboxylic acids and their anhydrides may be, for example: acrylic acid, methacrylic acid, fumaric acid, crotonic acid, itaconic acid, maleic acid and maleic anhydride, preferably acrylic acid.

Hydroxy-functional monomers include monoesters of α,β-unsaturated carboxylic acids such as acrylic acid, methacrylic acid (referred to for short in this specification as “(meth)acrylic acid”) with diols or polyols that have preferably 2 to 20 carbon atoms and at least two hydroxyl groups, such as ethylene glycol, diethylene glycol, triethylene glycol, 1,2-propylene glycol, 1,3-propylene glycol, 1,1-dimethylethane-1,2-diol, dipropylene glycol, triethylene glycol, tetraethylene glycol, pentaethylene glycol, tripropylene glycol, butane-1,4-diol, pentane-1,5-diol, neopentyl glycol, neopentyl glycol hydroxypivalate, 2-ethylpropane-1,3-diol, 2-methylpropane-1,3-diol, 2-butyl-2-ethylpropane-1,3-diol, hexane-1,6-diol, 2-methylpentane-1,5-diol, 2-ethylbutane-1,4-diol, 2-ethylhexane-1,3-diol, 2,4-diethyloctane-1,3-diol, 2,2-bis(4-hydroxycyclohexyl)propane, 1,1-, 1,2-, 1,3-, and 1,4-bis(hydroxymethyl)cyclohexane, 1,2-, 1,3- or 1,4-cyclohexanediol, glycerol, trimethylolethane, trimethylolpropane, trimethylolbutane, pentaerythritol, ditrimethylolpropane, dipentaerythritol, sorbitol, mannitol, diglycerol, threitol, erythritol, adonitol (ribitol), arabitol (lyxitol), xylitol, dulcitol (galactitol), maltitol, isomalt, polyTHF having a molecular weight between 162 and 4500, preferably 250 to 2000, poly-1,3-propanediol or polypropylene glycol having a molecular weight between 134 and 2000 or polyethylene glycol having a molecular weight between 238 and 2000.

Preference is given to 2-hydroxyethyl acrylate, 2-hydroxyethyl methacrylate, 2- or 3-hydroxypropyl acrylate, butane-1,4-diol monoacrylate or 3-(acryloyloxy)-2-hydroxypropyl acrylate, and particular preference to 2-hydroxyethyl acrylate and/or 2-hydroxyethyl methacrylate.

Examples of useful vinylaromatic compounds include vinyltoluene, α-butylstyrene, α-methylstyrene, 4-n-butylstyrene, 4-n-decylstyrene and, preferably, styrene.

Examples of nitriles include acrylonitrile and methacrylonitrile.

Examples of suitable vinyl ethers include vinyl methyl ether, vinyl isobutyl ether, vinyl hexyl ether, and vinyl octyl ether.

Nonaromatic hydrocarbons having 2 to 8 carbon atoms and one or two olefinic double bonds include butadiene, isoprene, and also ethylene, propylene, and isobutylene.

Additionally it is possible to use N-vinylformamide, N-vinylpyrrolidone, and N-vinylcaprolactam, and also ethylenically unsaturated acids, especially carboxylic acids, acid anhydrides or acid amides, and also vinylimidazole. Comonomers containing epoxide groups as well, such as glycidyl acrylate or methacrylate, for example, or monomers such as N-methoxymethylacrylamide or -methacrylamide, can be included in small amounts.

Preference is given to esters of acrylic acid and/or of methacrylic acid having 1 to 18, preferably 1 to 8, carbon atoms in the alcohol residue, such as methyl acrylate, ethyl acrylate, isopropyl acrylate, n-propyl acrylate, n-butyl acrylate, 2-ethylhexyl acrylate, n-stearyl acrylate, the methacrylates corresponding to these acrylates, styrene, alkyl-substituted styrenes, acrylonitrile, methacrylonitrile, vinyl acetate or vinyl stearate, or any desired mixtures of such monomers.

The monomers bearing hydroxyl groups are used, in the copolymerization of the (meth)acrylates bearing hydroxyl groups, in a mixture with other polymerizable monomers, preferably radically polymerizable monomers, preferably those which are composed to an extent of more than 50% by weight of C₁-C₂₀—, preferably C₁-C₄-, alkyl (meth)acrylate, (meth)acrylic acid, vinylaromatics having up to 20 carbon atoms, vinyl esters of carboxylic acids comprising up to 20 carbon atoms, vinyl halides, nonaromatic hydrocarbons having 4 to 8 carbon atoms and 1 or 2 double bonds, unsaturated nitriles, and mixtures thereof. Particularly preferred polymers are those which besides the monomers bearing hydroxyl groups are composed to an extent of more than 60% by weight of C₁-C₁₀-alkyl (meth)acrylates, styrene and its derivatives, or mixtures thereof.

The polymers can be prepared by polymerization, by conventional methods. Preferably the polymers are prepared in an emulsion polymerization or in organic solution. Continuous or discontinuous polymerization processes are possible. The discontinuous processes include the batch process and the feed process, the latter being preferred. In the feed process, the solvent is introduced as an initial charge, on its own or with a portion of the monomer mixture, this initial charge is heated to the polymerization temperature, the polymerization is initiated radically in the case of an initial monomer charge, and the remaining monomer mixture is metered in, together with an initiator mixture, in the course of 1 to 10 hours, preferably 3 to 6 hours. Subsequently, the batch is optionally reactivated, in order to carry out the polymerization to a conversion of at least 99%.

Further binders are, for example, polyester polyols as obtainable by condensation of polycarboxylic acids, especially dicarboxylic acids, with polyols, especially diols. In order to assure appropriate functionality of the polyester polyol for the polymerization, there is also some degree of use of triols, tetraols etc., and of triacids etc.

Polyester polyols are known, for example, from Ullmanns Enzyklopädie der technischen Chemie [Ullmann's Encyclopedia of Industrial Chemistry], 4th edition, vol. 19, p. 62 to 65. Preference is given to using polyester polyols obtained by reaction of dihydric alcohols with dibasic carboxylic acids. Instead of using free polycarboxylic acids, the polyester polyols may also be produced using the corresponding polycarboxylic anhydrides or the corresponding polycarboxylic esters of lower alcohols or mixtures thereof. The polycarboxylic acids may be aliphatic, cycloaliphatic, aromatic or heterocyclic and may be optionally substituted, for example by halogen atoms, and/or unsaturated. Examples thereof include:

oxalic acid, maleic acid, fumaric acid, succinic acid, glutaric acid, adipic acid, sebacic acid, dodecanedioic acid, o-phthalic acid, isophthalic acid, terephthalic acid, trimellitic acid, azelaic acid, 1,4-cyclohexanedicarboxylic acid or tetrahydrophthalic acid, suberic acid, azelaic acid, phthalic anhydride, tetrahydrophthalic anhydride, hexahydrophthalic anhydride, tetrachlorophthalic anhydride, endomethylenetetrahydrophthalic anhydride, glutaric anhydride, maleic anhydride, dimeric fatty acids, their isomers and hydrogenation products, and also esterifiable derivatives, such as anhydrides or dialkyl esters, C₁-C₄-alkyl esters for example, preferably methyl, ethyl or n-butyl esters, of said acids are used. Preference is given to dicarboxylic acids of the general formula HOOC—(CH₂)_{y}—COOH where y is a number from 1 to 20, preferably an even number from 2 to 20; more preferably hexahydrophthalic anhydride, succinic acid, adipic acid, sebacic acid, and dodecanedicarboxylic acid.

Useful polyhydric alcohols for preparation of the polyesterols include propane-1,2-diol, ethylene glycol, 2,2-dimethylethane-1,2-diol, propane-1,3-diol, butane-1,2-diol, butane-1,3-diol, butane-1,4-diol, 3-methylpentane-1,5-diol, 2-ethylhexane-1,3-diol, 2,4-diethyloctane-1,3-diol, hexane-1,6-diol, polyTHF having a molar mass between 162 and 4500, preferably 250 to 2000, polypropane-1,3-diol having a molar mass between 134 and 1178, polypropane-1,2-diol having a molar mass between 134 and 898, polyethylene glycol having a molar mass between 106 and 458, neopentyl glycol, neopentyl glycol hydroxypivalate, 2-ethylpropane-1,3-diol, 2-methylpropane-1,3-diol, 2,2-bis(4-hydroxycyclohexyl)propane, cyclohexane-1,1-, -1,2-, -1,3-, and -1,4-dimethanol, cyclohexane-1,2-, -1,3- or -1,4-diol, trimethylolbutane, trimethylolpropane, trimethylolethane, neopentyl glycol, pentaerythritol, glycerol, ditrimethylolpropane, dipentaerythritol, sorbitol, mannitol, diglycerol, threitol, erythritol, adonitol (ribitol), arabitol (lyxitol), xylitol, dulcitol (galactitol), maltitol or isomalt, which may optionally have been alkoxylated as described above.

Preferred alcohols are those of general formula HO—(CH₂)ₓ—OH where x is a number from 1 to 20, preferably an even number from 2 to 20. Preference is given to trimethylolpropane, glycerol, neopentyl glycol, ethylene glycol, butane-1,4-diol, hexane-1,6-diol, octane-1,8-diol and dodecane-1,12-diol.

In addition, polycarbonate diols are also useful, as can be obtained for example by reacting phosgene with an excess of the low molecular weight alcohols mentioned as formation components for the polyester polyols.

Other polyester diols which are suitable are based on lactones, taking the form of lactone homopolymers or mixed polymers, preferably of adducts of lactones onto suitable difunctional starter molecules, having terminal hydroxyl groups. Useful lactones are preferably those derived from compounds of general formula HO—(CH₂)_{z}—COOH where z is a number from 1 to 20 and one hydrogen atom of a methylene unit may also be substituted by a C₁- to C₄-alkyl radical. Examples are ε-caprolactone, β-propiolactone, gamma-butyrolactone and/or methyl-ε-caprolactone, 4-hydroxybenzoic acid, 6-hydroxy-2-naphthoic acid or pivalolactone, and mixtures thereof. Examples of suitable starter components are the low molecular weight dihydric alcohols which have been mentioned above as formation component for the polyester polyols. The corresponding polymers of ε-caprolactone are particularly preferred. Lower polyester diols or polyether diols may also be employed as starters for producing the lactone polymers. Instead of the polymers of lactones, the corresponding chemically equivalent polycondensates of the hydroxycarboxylic acids corresponding to the lactones may also be employed.

In polyurethane coatings, molar masses Mₙ of the polyesters of 800-4000 g/mol are customary, although the polyesters used here are not limited thereto.

Further suitable binders are also polyetherols, which are prepared by addition of ethylene oxide, propylene oxide and/or butylene oxide, preferably ethylene oxide and/or propylene oxide and more preferably ethylene oxide, onto H-active components.

Likewise suitable are polycondensates of butanediol. In polyurethane coatings, molar masses of the polyethers of 500-2000 g/mol are customary, although the polyethers used here are not limited thereto.

The polymers may be at least partly replaced by what are called reactive diluents. These may be blocked secondary or primary amines (aldimines and ketimines) or compounds having sterically hindered and/or electron-deficient secondary amino groups, for example aspartic esters according to EP 403921 or WO 2007/39133.

For curing of the film, polyisocyanate composition and binder are mixed with one another in a molar ratio of isocyanate groups to isocyanate-reactive groups of 0.2:1 to 5:1, preferably 0.8:1 to 1.2:1 and especially 0.9:1 to 1.1:1, and it is optionally possible to mix in further customary coatings constituents, and the mixture is applied to the substrate and cured at ambient temperature up to 150° C.

The coating mixture is preferably cured at a temperature between room temperature and 140° C.

In a particularly preferred variant, the coating mixture is cured at ambient temperature to 80° C., more preferably to 60° C., most preferably to 40° C. The curing can also be effected by infrared radiation. The articles involved are preferably those that cannot be cured at high temperatures, such as large machinery, aircraft, large vehicles and refinishes, optionally plastics.

In another preferred application, the coating mixture is cured at 110-140° C. (for example for OEM applications).

“Curing” in the context of the present invention is understood to mean the creation of a tack-free coating on a substrate by heating the coating material applied to the substrate to the above-specified temperature at least until at least the desired freedom from tack has occurred.

In the context of the present document, a coating material is understood to mean a mixture at least of the components intended for coating of at least one substrate for the purpose of forming a film and, after curing, a tack-free coating.

The substrates are coated by typical methods known to the skilled person, with at least one coating composition being applied in the desired thickness to the substrate to be coated, and the volatile constituents optionally present in the coating composition being removed, optionally with heating. This operation may if desired be repeated one or more times. Application to the substrate may take place in a known way, such as for example by spraying, troweling, knifecoating, brushing, rolling, roller coating, pouring, laminating, injection-backmolding or coextruding.

The thickness of a film of this kind for curing may be from 0.1 μm up to several mm, preferably from 1 to 2000 μm, more preferably 5 to 200 μm, very preferably from 5 to 60 μm, especially 20 to 50 μm (based on the coating material in the state in which the solvent has been removed from the coating material).

Additionally provided by the present invention are substrates coated with a multicoat paint system of the invention.

Polyurethane coating materials of this kind are especially suitable for applications requiring particularly high application reliability, exterior weathering resistance, optical qualities, solvent resistance, chemical resistance and water resistance.

The two-component coating compositions and coating formulations obtained are suitable for coating substrates such as wood, wood veneer, paper, cardboard, paperboard, textile, film, leather, nonwoven, plastics surfaces, glass, ceramic, mineral building materials, such as molded cement blocks and fiber-cement slabs, or metals, which in each case may optionally have been precoated or pretreated, preferably metals, precoated surfaces and plastics.

Coating compositions of this kind are suitable as or in interior or exterior coatings, i.e., in those applications where there is exposure to daylight, preferably of parts of buildings, coatings on (large) vehicles and aircraft, and industrial applications, utility vehicles in agriculture and construction (ACE), decorative coatings, bridges, buildings, power masts, tanks, containers, pipelines, power stations, chemical plants, ships, cranes, posts, sheet piling, valves, pipes, fittings, flanges, couplings, halls, roofs, and structural steel, furniture, windows, doors, wood flooring, can coating and coil coating, for floor coverings, such as in parking levels or in hospitals, in automotive finishes as OEM and refinish applications, more preferably refinish and industrial applications.

More particularly, the coating compositions of the invention are used as clearcoat(s), basecoat(s) and outer coat(s), topcoats, primers and primer surfacers, preferably as clearcoats.

Polyisocyanate compositions of this kind can be used as curing agent in coatings, adhesives and sealants; they are preferably used in coatings.

It is an advantage of the polyisocyanate compositions of the invention that they keep polyisocyanate mixtures color-stable over a long period in the presence of urethanization catalysts.

### EXAMPLES

Feedstocks:

Amount figures in ppm are generally ppm by weight.

Polyisocyanate A: isocyanurate based on hexamethylene diisocyanate: hexamethylene diisocyanate HDI was converted at 120° C. in the presence of 60 ppm by weight of benzyltrimethylammonium hydroxyisobutyrate as catalyst, based on hexamethylene diisocyanate, 5% in ethylhexanol, in a cascade consisting of three reactors each with an average throughput time of 40 min. The reaction was stopped in a static mixer with 22% di(2-ethylhexyl) phosphate, in stoichiometric terms based on the catalyst, in a 10% solution in hexamethylene diisocyanate. Hexamethylene diisocyanate was distilled off via multiple distillation stages. NCO content of the product: 22.2%, color number 19 Hz; viscosity: 2630 mPa*s.

Sterically hindered phenols B:

Inventive:

Phenol B1: Polyethylene glycol bis[3-(3,5-di-tert-butyl-4-hydroxyphenyl)propionate]having an average molecular weight Mᵣ of 978 g/mol and a melting point of −2° C.: 500 g of polyethylene glycol (Mw=201.8 g/mol, 2.5 mol) were combined with 1310 g methyl 3-(3,5-di-tert-butyl-4-hydroxphenyl)propionate (292.4 g/mol; 5 mol) and 500 ppm of dibutyltin dilaurate in a 300 mL flask. The mixture was heated to 170° C. Nitrogen was passed cautiously through the solution. The resultant methanol was condensed out in a Liebig condenser. After 18 h, the reaction was ended. Analysis by means of GPC confirms the complete conversion of the starting components.

The number-average molecular weight Mₙ was determined by gel permeation chromatography against polystyrene standard in tetrahydrofuran at (23±1°) C. Further measurement conditions are specified below:
Injector: Autosampler WATERS 717 Plus
Eluent: tetrahydrofuran (flow rate: 1 mL/min)
Pump: WATERS Model 515 (double piston pump)
Detector 1: WATERS 2489 UV detector (wavelength: 254 nm)
Detector 2: WATERS 2414 differential refractometer (measurement temperature: 35° C.)
Column set: PL gel columns (300×7.5 mm), 4 columns connected in series: Column material: crosslinked polystyrene-divinylbenzene matrix, particle size 5 μm: Pore size: 2×500 Å; 1×1000 Å, 1×10000 Å
Calibration: polystyrene standard, molar mass range 450 000-312 g/mol
Software: PSS WinGPC Unity NT
Noninventive (comparison):
Phenol B2: C7-C9-branched alkyl ester 3-(3,5-di-tert-butyl-4-hydroxyphenyl)propionate (Irganox® 1135 from BASF SE)
Phenol B3: 2,6-di-tert-butyl-4-methylphenol (BHT)
Phenol B4: pentaerythritol tetrakis[3-(3,5-di-tert-butyl-4-hydroxyphenyl)propionate](Irganox® 1010 from BASF SE) branched tetraphenol
Catalyst C: dibutyltin dilaurate (DBTL, DBTDL)
Solvent D:
D1: Solvent Naphtha (Solvesso® 100, boiling range about 170-180° C.):
D2: methyl ethyl ketone
Antioxidant E:
E1: dioctyl phosphonate (Irgafos® OPH from BASF SE)
E2: triphenyl phosphite (Tppt, Aldrich)

Various demands are made on the phenols (B):

They should have good solubility in pure polyisocyanate (A) in production within normal processing times. Solubilities of phenol (B) in polyisocyanate (A) were determined with 1% and 10% phenol (B) in the commercial Basonat® HI 100 polyisocyanurate by rolling a sample on a roller at a speed of 35 revolutions/min at room temperature. For good incorporability, it was determined that the phenol (B) must dissolve in at least 10% within 30 minutes at room temperature in order not to cause any technical problems in industrial incorporation.

Storage stabilities of mixtures of the polyisocyanates (A), Lewis acids (C), solvents (D), especially comprising Solvesso® 100 and/or ketones, and inventive phenols (B) should be the same as or better than prior art with regard to color drift.

Storage tests were effected in firmly closed screwtop vessels under nitrogen. Traces of air cannot be ruled out. The studies were effected with 25 g in 25 mL vessels at 50° C. in an air circulation oven. Color numbers were measured prior to commencement of storage, and storage after different periods of time. After a color measurement, the materials were returned to the screwtop vessels and inertized by purging with nitrogen.

The percentages by weight relate to 100% total weight based on polyisocyanate (A) and solvent (D). The concentrations of the compounds (B), (C), (E) in ppm, in the respectively undiluted state of compounds (B), (C), (E), are based on the total amount of polyisocyanate (A).

Color number was measured in APHA to DIN EN 1557 on a Lico 150 from Lange in a 5 cm analytical cuvette with a volume of 5 mL.

The number-average molecular weight M of the phenols (B) should exceed 650 D in order to reduce fogging.

The phenols (B) should be liquid at room temperature, and hence be able to be efficiently industrially handled and incorporable into polyisocyanate. Preference is given to a melting point below 5° C.

In toxicological terms, the products should not have any labeling.

Test series 1: In the table below, an inventive phenol (B1) is compared to two noninventive phenols by their solubilities in a commercial polyisocyanate (Basonat® HI 100), and the number-average molecular weights Mₙ and melting points.

| | | | Number- | |
|---|---|---|---|---|
| | | | average | |
| | | | molecular | |
| | | | weight Mₙ | Melting point |
| | Phenol B | Solubility | [D] | [° C.] |
| Ex. | B1 | [++] 10% 30′ roller | 978 | (−2) |
| | | RT | | |
| Comp. | B2 | [++] 10% 20′ roller | 399 | <(−30) |
| | | RT | | |
| Comp. | B3 | [−]10% 24 h roller | 220 | 69 |
| | | RT | | |
| | | [−] 10% 30′ 80° C. | | |
| Comp. | B4 | −−/1% 15′ 110° C. | 1178 | 112 |

Phenol B1 is inventive, is liquid with a melting point of −2° C., has no labeling requirement and has good solubility in polyisocyanate.

Of the comparative phenols, isooctyl 3-(3,5-di-tert-butyl-4-hydroxyphenyl)propionate B2 meets the demands on good solubility and processibility. But it is not toxicologically preferred and has a molecular weight below 400 g/mol, and therefore significant fogging.

The other noninventive phenols B3 and B4 have poor solubility, are solid, have a lower molecular weight and/or toxicologically undesirable properties.

Test series 2: Storage of 50% by weight of polyisocyanate A with inventive and noninventive additive (B) in stoichiometrically equal amounts, 1000 ppm of Lewis acid DBTL (C), 50% by weight of Solvesso® 100 solvent (D1) at 50° C. with reported color numbers.

| | | Phenol | | Antioxidant | | | | |
|---|---|---|---|---|---|---|---|---|
| | Phenol | [ppm | Phenol | (E) | Storage time | | | |
| Examples | [micromol/kg] | by wt.] | (B) | [ppm] | 0 | 23 d | 70 d | 105 d |
| Ex. 1 | 0.5 | 360 | B1 | 200 E1 | 13 | 78 | 141 | 176 |
| Comp. 1 | 0.5 | 200 | B2 | 200 E1 | 13 | 83 | 148 | 187 |

The example is better in terms of color drift than the reference.

Test series 3: Storage of 50% by weight of polyisocyanate A with inventive and noninventive additives (B) in stoichiometrically equal amounts, 1000 ppm of Lewis acid DBTL (C), 50% by weight of methyl amyl ketone solvent (D2) at 50° C. with reported color numbers.

| | | Phenol | | Antioxidant | | | | |
|---|---|---|---|---|---|---|---|---|
| | Phenol | [ppm | Phenol | (E) | Storage time | | | |
| Examples | [micromol/kg] | by wt.] | (B) | [ppm] | 0 d | 23 d | 70 d | 105 d |
| Ex. 2 | 0.5 | 360 | B1 | | 18 | 37 | 65 | 89 |
| Comp. 2 | 0.5 | 200 | B2 | | 18 | 55 | 82 | 117 |
| Ex. 3 | 0.5 | 360 | B1 | 200 E2 | 17 | 35 | 34 | 43 |
| Comp. 3 | 0.5 | 200 | B2 | 200 E2 | 17 | 52 | 97 | 133 |
| Comp. 4 | 0.5 | 110 | B3 | 200 E2 | 17 | 37 | 39 | 59 |
| Ex. 4 | 0.5 | 360 | B1 | 200 E1 | 17 | 32 | 45 | 80 |
| Comp. 5 | 0.5 | 200 | B2 | 200 E1 | 17 | 57 | 97 | 121 |

The examples are better in terms of color drift than the reference.

Test series 4: Storage of 50% by weight of polyisocyanate Ain inventive and noninventive additives (B) in stoichiometrically equal amounts, all not in accordance with the invention in the absence of Lewis acid DBTL (C), in the presence of 50% by weight of Solvesso® 100 solvent (D1) at 50° C. with reported color numbers (specimen as in test series 2).

| | | Phenol | | Antioxidant | | | | |
|---|---|---|---|---|---|---|---|---|
| | Phenol | [ppm | Phenol | (E) | Storage time | | | |
| Examples | [micromol/kg] | by wt.] | (B) | [ppm] | 0 d | 23 d | 70 d | 105 d |
| Comp. 6 | 0.5 | 360 | B1 | 200 E1 | 12 | 22 | 18 | 18 |
| Comp. 7 | 0.5 | 200 | B2 | 200 E1 | 12 | 16 | 15 | 23 |

Color drift in the absence of DBTL is marginal. The differences in color number after storage are within the order of magnitude of measurement errors. Color number drift in the absence of Lewis acid is not relevant under the storage conditions.

Test series 5: Storage of 50% by weight of polyisocyanate A with inventive and noninventive additives (B) in stoichiometrically equal amounts, all not in accordance with the invention in the absence of Lewis acid DBTL (C), in the presence of 50% by weight of methyl amyl ketone solvent (D2) at 50° C. with reported color numbers (specimen as in test series 3).

| | | Phenol | | Antioxidant | | | | |
|---|---|---|---|---|---|---|---|---|
| | Phenol | [ppm | Phenol | (E) | Storage time | | | |
| Examples | [micromol/kg] | by wt.] | (B) | [ppm] | 0 d | 23 d | 70 d | 105 d |
| Comp. 8 | 0.5 | 360 | B1 | | 11 | 30 | 26 | 28 |
| Comp. 9 | 0.5 | 200 | B2 | | 11 | 26 | 25 | 27 |
| Comp. 10 | 0.5 | 360 | B1 | 200 E2 | 11 | 19 | 25 | 26 |
| Comp. 11 | 0.5 | 200 | B2 | 200 E2 | 11 | 22 | 23 | 23 |
| Comp. 12 | 0.5 | 110 | B3 | 200 E2 | 11 | 22 | 24 | 26 |
| Comp. 13 | 0.5 | 360 | B1 | 200 E1 | 11 | 29 | 31 | 34 |
| Comp. 14 | 0.5 | 200 | B2 | 200 E1 | 11 | 33 | 36 | 43 |

Color number drift in the absence of Lewis acid is not relevant under the storage conditions. Color drift in the absence of DBTL is marginal. The differences in color number after storage are generally within the order of magnitude of measurement errors.

Since (B1) has a higher equivalent weight in relation to the phenyl groups than Irganox® 1135 (B2) and BHT (B3), curing characteristics and application technique were examined for plasticizing effect. No adverse effect was found.

1: A polyisocyanate composition, comprising:
(A) at least one (cyclo)aliphatic polyisocyanate obtained by reacting at least one monomeric isocyanate,
(B) at least one sterically hindered phenol having a melting point of below 40° C. and a number-average molecular weight Mₙ between 650 and 2550 g/mol, comprising at least two phenolic groups,
(C) at least one Lewis-acidic organic metal compound capable of accelerating the reaction of isocyanate groups with isocyanate-reactive groups,
(D) at least one solvent,
(E) optionally at least one further antioxidant,
(F) optionally at least one Brønsted acid having a pKa less than 4,
(G) optionally other coatings additives.

2: The polyisocyanate composition according to claim 1, wherein the monomeric isocyanate is a diisocyanate selected from the group consisting of hexamethylene 1,6-diisocyanate, pentamethylene 1,5-diisocyanate, isophorone diisocyanate, 1,3-bis(isocyanatomethyl)cyclohexane, 4,4′-di(isocyanatocyclohexyl)methane and 2,4′-di(isocyanatocyclohexyl)methane.

3: The polyisocyanate composition according to claim 1, wherein the polyisocyanate (A) has isocyanurate groups, biuret groups, allophanate groups, urethane groups, uretdione and/or iminooxadiazinedione groups.

4: The polyisocyanate composition according to claim 1, wherein the polyisocyanate (A) has an NCO content in the range from 5% to 25% by weight.

5: The polyisocyanate composition according to claim 1, wherein the polyisocyanate (A) comprises isocyanurate groups and/or allophanate/urethane groups that have been prepared using an ammonium carboxylate, ammonium hydroxycarboxylate or ammonium hydroxide catalyst.

6: The polyisocyanate composition according to claim 1, wherein the polyisocyanate is a polyisocyanate comprising primarily isocyanurate groups and having a viscosity of 500-4000 mPa*s and/or a low-viscosity allophanate optionally comprising isocyanurate and/or urethane and having a viscosity of 150-1600 mPa*s and/or an iminooxadiazinedione optionally containing isocyanurate and having a viscosity of 300-1200 mPa*s.

7: The polyisocyanate composition according to claim 1, wherein compound (B) has exactly one phenolic hydroxyl group per aromatic ring and is substituted in both ortho positions relative to the phenolic hydroxyl group by alkyl radicals.

8: The polyisocyanate composition according to claim 1, wherein compound (B) has the following structure of a polyalkylene oxide bis-, tris- or tetra[3-(3,5-dialkyl-4-hydroxyphenyl)propionate]: 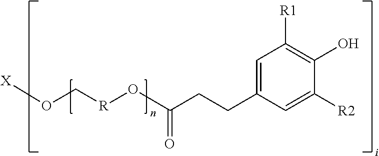
where
R is an optionally substituted C₁-C₅-alkyl radical which is linear or branched and may be different from repeat unit [—CH₂—R—O-] to repeat unit [—CH₂—R—O—];
i is an integer from 2 to 4;
n is a natural number (including 0), where the 2, 3 or 4 n per compound (B) may be the same or different, and where the sum total of the 2, 3 or 4 n in the compound (B) on average over all molecules (B) is greater than 2 and not more than 45;
R1, R2 are identical or different alkyl groups, where the 2, 3 or 4 R1 and R2 per compound (B) may be the same or different; and
X is an aliphatic di-, tri- or tetrafunctional aliphatic linear or branched radical.

9: The polyisocyanate composition according to claim 1, wherein compound (B) has the following structure of a polyalkylene oxide bis[3-(3,5-alkyl-4-hydroxyphenyl)propionate]: 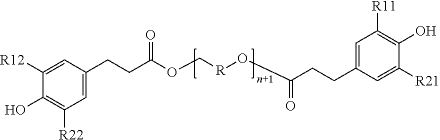
where
R is an optionally substituted C₁-C₅-alkyl radical which is linear or branched and may be different from repeat unit [—CH₂—R—O-] to repeat unit [—CH₂—R—O—];
n is a natural number, where (n+1) in the compound (B) on average over all molecules (B) is greater than 3 and not more than 46; and
R11, R21, R12 and R22 are identical or different alkyl groups.

10: The polyisocyanate composition according to claim 1, wherein the Lewis-acidic organic metal compound (C) comprises a metal selected from the group consisting of tin, zinc, titanium, zirconium and bismuth, or mixtures of such compounds.

11: The polyisocyanate composition according to claim 1, wherein the solvent (D) is selected from the group consisting of aromatic hydrocarbons, (cyclo)aliphatic hydrocarbons, ketones, esters, ethers, ether esters and carbonates, especially from distillation cuts of aromatic hydrocarbons comprising predominantly C₉ and C₁₀ aromatics, and from dialkyl ketones, or mixtures thereof.

12: The polyisocyanate composition according to claim 1, comprising at least one antioxidant (E) selected from the group of the phosphites, phosphonites, phosphonates and thioethers.

13: A process for stabilizing a polyisocyanate composition comprising at least one polyisocyanate (A), the process comprising blending the polyisocyanate composition with:
at least one sterically hindered phenol (B) having a melting point below 40° C. and a number-average molecular weight between 650 and 2550 g/mol, said sterically hindered phenol (B) comprising at least two phenolic groups;
at least one Lewis-acidic organic metal compound (C) capable of accelerating the reaction of isocyanate groups with isocyanate-reactive groups;
at least one solvent (D);
optionally at least one further antioxidant (E);
optionally at least one Brønsted acid having a pKa of less than 4 (F); and
optionally other coatings additives (G).

14: A process for producing polyurethane coatings, the process comprising reacting a polyisocyanate composition of claim 1 with at least one binder comprising isocyanate-reactive groups.

15: A process for producing polyurethane coatings, the process comprising reacting a polyisocyanate composition of claim 1 with at least one binder selected from the group consisting of polyacrylate polyols, polyester polyols, polyether polyols, polyurethane polyols, polyurea polyols, polyetherols, polycarbonates, polyester polyacrylate polyols, polyester polyurethane polyols, polyurethane polyacrylate polyols, polyurethane-modified alkyd resins, fatty acid-modified polyester polyurethane polyols, copolymers with allyl ethers and copolymers or graft polymers from the substance groups mentioned.

16: A curing agent, comprising the polyisocyanate composition of claim 1 and adapted to function as curing agent in primers, primer surfacers, pigmented topcoats, coatings, adhesives, sealants, and in basecoats and clearcoats in sectors of refinishing, automotive repair, OEM finishing of automobiles, large vehicles and wood.
